(19) United States
(12) Patent Application Publication
(10) Pub. No.: US 2026/0152423 A1
(43) Pub. Date: Jun. 4, 2026

(54) A CONCENTRIC REACTOR FOR TREATING WASTES FROM LAND-BASED AQUACULTURE SYSTEMS

(71) Applicants: Everblue Labs Ltd., Tel Aviv (IL); Yissum Research Development Company of the Hebrew University of Jerusalem Ltd., Jerusalem (IL)

(72) Inventors: Snir AZARIA, Tel Aviv (IL); Jaap VAN RIJN, Rehovot (IL)

(73) Assignees: Everblue Labs Ltd., Tel Aviv (IL); Yissum Research Development Company of the Hebrew University of Jerusalem Ltd., Jerusalem (IL)

(21) Appl. No.: 19/123,937

(22) PCT Filed: Oct. 29, 2023
(86) PCT No.: PCT/IL2023/051113

§ 371 Date: Apr. 24, 2025

Related U.S. Application Data
(60) Provisional application No. 63/419,730, filed on Oct. 27, 2022.

(51) Int. Cl. C02F 3/28; A01K 61/10; A01K 63/04; C02F 1/00; C02F 3/00; C02F 3/34; C02F 101/34; C02F 103/20

(52) U.S. Cl. CPC C02F 3/2866; A01K 61/10; A01K 63/04; C02F 3/006; C02F 3/34; C02F 2001/007; C02F 2101/34; C02F 2103/20; C02F 2203/006; C02F 2209/02; C02F 2209/42; C02F 2305/06

(57) ABSTRACT

A system for removing compounds from liquids, the system comprises: multiple ring-shaped channels that enable flow of liquids from one ring-shaped channel to another ring-shaped channel; an inlet coupled to one of the ring-shaped channels, said inlet receives the liquids that comprises the compounds to be removed; a central container coupled surrounded by the multiple ring-shaped channels; a tube coupled to the central container, said tube is configured to output the treated liquids from the system; a temperature unit configured to regulate the temperature of the liquids in the multiple ring-shaped channels; a carbon source reservoir and delivery system for supplying carbon source to at least one of the multiple ring-shaped channels; one or more sensors configured to collect information about the liquids in the multiple ring-shaped channels; a control unit configured to receive the information from the one or more sensors, said control unit activates the carbon reservoir, the temperature unit and the vertical locks according to the collected information.

### FIELD

The invention relates to the field of treating wastes from land-based aquaculture systems.

### BACKGROUND

Recirculating aquaculture systems (RAS) are used in for freshwater fish and for land-based production of seafood (e.g. fish, shrimps), where water exchange is limited and the use of biofiltration is required to reduce ammonia toxicity.[1] Other types of filtration and environmental control are often also necessary to maintain clean water and provide a suitable habitat for fish.[2] The main benefit of RAS is the ability to reduce the need for fresh, clean water while still maintaining a healthy environment for fish.

Many times, a significant amount of environmentally harmful nitrate and organic sludge accumulate from recirculating aquaculture systems. In addition, geosmin and 2-methylisoborneol accumulate in many of these systems, render the fish unmarketable, and lead to excessive water usage and weight loss of the harvested fish.

Several technologies (denitrification reactors) for nitrate removal are commercially available and have been applied mainly in wastewater treatment plants. Some fish farmers incorporate a denitrifying reactor in their farm to comply with regulatory nitrate levels in the effluent water prior to their discharge. In such systems, the denitrifying reactors are not used for on-line treatment but rather as end-of-pipe treatment and are fueled with an external carbon source. Sludge removal technologies in aquaculture are mainly for end-of-pipe treatment systems and are designed to mechanically thicken and dry the sludge to a powder-like by-product.

End-of-pipe treatment, commonly used for removal of sludge and nitrate from aquaculture effluents, does not allow for significant water savings and reuse. Moreover, its operational costs are much higher due to the need for external carbon sources (for denitrification) and the energy-consuming sludge separation and thickening equipment.

### SUMMARY OF THE INVENTION

The subject matter discloses a system for removing compounds from liquids, the system comprises: multiple ring-shaped channels that enable flow of liquids from one ring-shaped channel to another ring-shaped channel; an inlet coupled to one of the ring-shaped channels, said inlet receives the liquids that comprises the compounds to be removed; a central container coupled surrounded by the multiple ring-shaped channels;
a tube coupled to the central container, said tube is configured to output the treated liquids from the system; a temperature unit configured to regulate the temperature of the liquids in the multiple ring-shaped channels; a carbon source reservoir and delivery system for supplying carbon source to at least one of the multiple ring-shaped channels; one or more sensors configured to collect information about the liquids in the multiple ring-shaped channels; a control unit configured to receive the information from the one or more sensors, said control unit activates the carbon reservoir, the temperature unit and the vertical locks according to the collected information.

In some cases, the multiple ring-shaped channels are concentric. In some cases, the multiple ring-shaped channels and the central container comprise a base and sidewalls extending upwards from the base. In some cases, the system further comprises an outlet pipe coupled to the tube, said outlet pipe is configured to transfer the treated liquids from the central container to a remote tank. In some cases, the reactor is configured to operate in aquaculture systems that operate at water temperatures of 10-30° C.

In some cases, the multiple ring-shaped channels comprise at least an external ring that surrounds an internal ring, wherein the inlet is coupled to the external ring shaped channel. In some cases, the external ring comprises a deflector located substantially close to the inlet, such that the deflector regulates a direction of liquid flow in the external ring. In some cases, the external ring and the internal ring comprise one or more movable vertical locks configured to regulate the flow of liquid in the rings.

The subject matter discloses a method for removing compounds from liquids, the method comprises receiving wastewater flow into one of multiple ring-shaped channels; forcing the wastewater to flow in a unidirectional manner along the multiple ring-shaped channels; formation of the sludge layer at the base of the multiple ring-shaped channels; digesting the sludge layer by fermentative bacteria at a lower section of the sludge layer.

In some cases, the digesting further comprises a fermentation process results in production of CO2 gas and volatile fatty acids (VFAs). In some cases, the method further comprises absorbing geosmin and 2-methylisoborneol onto sludge particles in the sludge layer, and subsequently degraded by terpene-degrading bacteria. In some cases, the method further comprises maintaining the sludge at a given range of temperature; detecting a heating condition of the sludge layer; heating the sludge.

In some cases, the method further comprises detecting sludge level height and moving the vertical locks in response to detecting the sludge level height. In some cases, the one or more vertical locks move upwards and downwards, wherein an upward position of the vertical locks prevents a passage of the liquids in the ring. In some cases, the method further comprises detecting a carbon-limited condition and injecting the carbon into the fermentation layer of the sludge.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the Drawings:

FIG. 1 shows a concentric system for treating liquids in a closed environment, according to exemplary embodiments of the present invention.

FIG. 2 shows a method for transferring liquid in a closed system, according to exemplary embodiments of the present invention.

FIG. 3 shows a biological process occurring to the wastewater when transferred in a closed system, according to exemplary embodiments of the present invention.

FIG. 4 shows a method of regulating the transfer of the wastewater in a closed system, according to exemplary embodiments of the present invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

The present invention discloses a concentric reactor in which effluent water and sludge from fish tanks in a recirculating aquaculture system is treated for removal of nitrate, sludge and the off-flavor compounds, geosmin and 2-methylisoborneol. By manipulation of water retention time, sludge level height, oxidation-reduction potential (ORP), carbon/nitrogen ratio and temperature in a concentric, compartmentalized reactor, conditions are created whereby sludge is biologically digested to volatile fatty acids. These latter compounds serve as carbon and energy sources to allow reduction of nitrate to elemental nitrogen gas by heterotrophic denitrifying bacteria. Incorporation of this treatment step allows the operation of these recirculating systems in a complete closed mode without the need for discharge of nitrate-rich water and sludge.

The environmental conditions maintained in the reactor also allow the removal of waterborne geosmin and 2-methylisoborneol. Removal of these latter compounds takes place by a combination of their adsorption to sludge particles and subsequent degradation by endemic terpene-degrading, denitrifying bacterial consortium. The removal process secures the organoleptic quality of the cultured fish, thus eliminating the need to purge the fish prior to harvest.

The reactor is suitable for both marine and freshwater aquaculture systems, operated at water temperatures of 10-30° C.

The present invention discloses an on-line treatment system, allows for a controlled separation of sludge from the culture water followed by its anoxic digestion. Nitrate is effectively eliminated in the reactor by denitrifying bacteria that are fueled by endemic carbon and energy sources. Waterborne off-flavor compounds in the reactor are degraded by the native bacterial fauna.

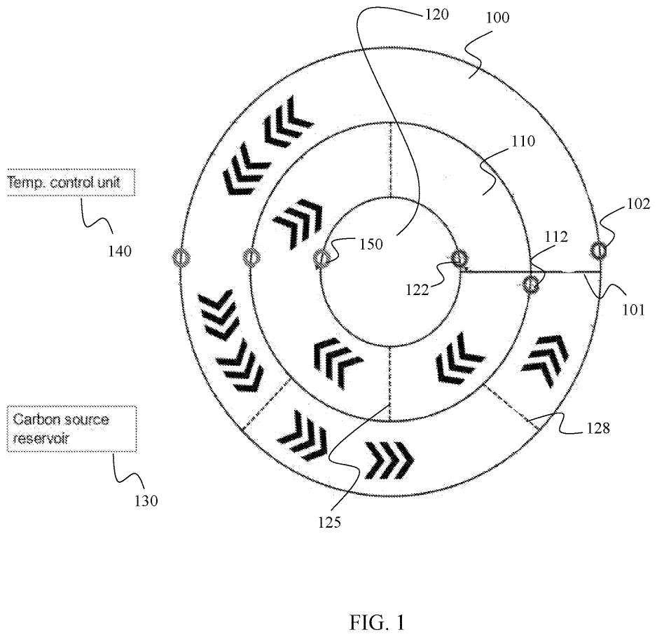

FIG. 1 shows a concentric system for treating liquids in a closed environment, according to exemplary embodiments of the present invention.

The concentric system comprises multiple ring-shaped channels that enable flow of liquids therein. The rings surround a central container coupled to a tube configured to output the treated liquids from the system. The central container has an outlet port 150 configured to be coupled to an output tube that outputs the treated liquids. The rings are defined as a shape of an elliptical, polygonal, or circular cross-section that enables liquids to flow therein, with minimal or without remainders left on the side walls of the channels. The channels and the central container comprise a base and sidewalls extending upwards from the base. The system may comprise two or more rings, in addition to the central container.

Each of the multiple ring-shaped channels and the central container have an inlet port and an outlet port. The liquids are provided into the system at the inlet port 102 of the external ring 100. The external ring 100 may be equipped with a deflector 101 located substantially close to the inlet port 102, such that the deflector 101 regulates the direction of liquid flow in the external ring 100. The liquids exit the external ring 100 via intermediate port 112 which creates a passage between the external ring 100 and the central ring 110. The liquids exit the central ring 110 via inner port 122 which creates a passage between the central ring 110 and the central container 120. The central container 120 has an outlet port 150 to output the treated liquids back to the fish container.

The base and sidewalls of the rings and the central container may be made of concrete, polypropylene, polyethylene and similar plastic-based polymers, fiberglass, glass-reinforced polymer, protruded fiberglass, galvanized steel, aluminum, and similar metal-based building materials desired by a person skilled in the art.

The rings may comprise one or more movable vertical locks 125, 128. For example, external ring 100 may comprise vertical lock 128 and central ring 105 may comprise vertical lock 125. The vertical locks 125, 128 regulate the flow of liquid in the rings. The vertical locks 125, 128 are movable upwards and downwards, either manually, by a person, or using a mechanism such as an actuator, springs, pins, and the like.

The system also comprises an outlet pipe configured to transfer the treated wastewater from the central container to a remote tank located outside the system. The remote rank may be a tank used to grow fish. In some cases, said outlet pipe is coupled to outlet port 150 of the central container 120.

The system also comprises a temperature unit 140 configured to regulate the temperature of the wastewater. The temperature unit 140 may comprise heat exchangers or another mechanism or device capable of heating and/or cooling the wastewater.

The system also comprises a carbon source reservoir and delivery system for supplying carbon source to the wastewater. The carbon reservoir may be controlled by a control unit that manages the processes performed in the system.

The control unit may receive signals from sensors located in the system, such as a chemical sensor, cameras, temperature sensors and the like, and may activate modules in the system, such as the carbon reservoir 130, the temperature unit 140, the vertical locks 125, 128 and the like.

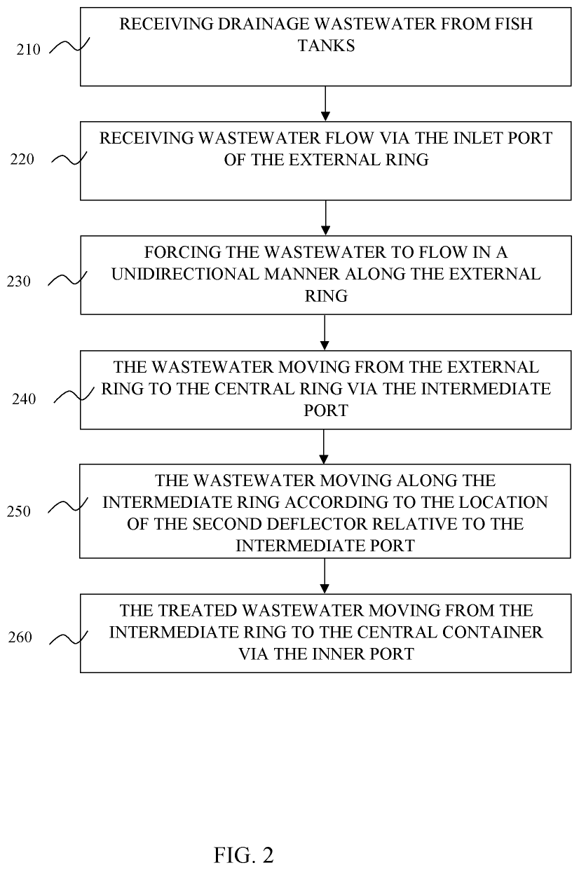

FIG. 2 shows a method for transferring liquid in a closed system, according to exemplary embodiments of the present invention.
Step 210 discloses receiving drainage wastewater from fish tanks. The drainage wastewater may be provided from the bottom part of the tanks. The drainage wastewater may contain organic solids (fish fecal waste and uneaten feed pellets). The drainage wastewater may move using gravitational flow to the inlet port of the external ring.
Step 220 discloses receiving wastewater flow via the inlet port of the external ring. The inlet port of the external ring may be controllable, to enable and disable the discharge of the wastewater into the external ring.
Step 230 discloses forcing the wastewater to flow in a unidirectional manner along the external ring. A unidirectional manner may be defined as a clockwise or counter-clockwise direction. The wastewater may be guided in the desired direction from the inlet port of the external ring using an external deflector located between the outer and intermediate rings' inner walls. The deflector may be a wall or a plate located close to the inlet port, extending upwards from the rings'bases, securing the movement of the wastewater in one direction, such that the wastewater is forced to a direction other than the direction of the deflector.
Step 240 discloses the wastewater moving from the external ring to the central ring via the intermediate port.
Step 250 discloses the wastewater moving along the intermediate ring according to the location of the second deflector relative to the intermediate port. The flow may be in a clockwise manner or counter-clockwise, according to the system's design.
Step 260 discloses the treated wastewater moving from the intermediate ring to the central container via the inner port.

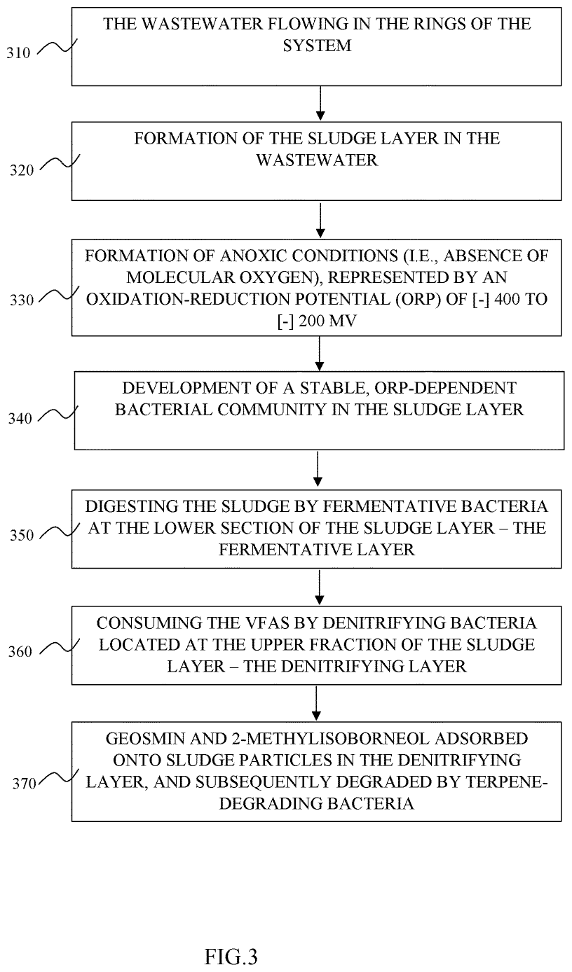

FIG. 3 shows a biological process occurring to the wastewater when transferred in a closed system, according to exemplary embodiments of the present invention.
Step 310 discloses the wastewater flowing in the rings of the system. The flow may be in a unidirectional, laminar manner defined by the base and sidewalls of the rings. The concentric design of the system creates adequate conditions for the sedimentation of solids in the wastewater, thus allowing the formation of a bottom sludge layer.
Step 320 discloses formation of the sludge layer at the base of the rings. The height of the sludge layer may be limited to a certain height, for example, a maximum height of 1 meter from the base of the rings. The maximum height represents steady-state conditions is sludge layer height.
Step 330 discloses formation of anoxic conditions (i.e., absence of molecular oxygen), represented by an oxidation-reduction potential (ORP) of [−]400 to [−]200 mV. The anoxic conditions result from the formation of the sludge layer in the rings.
Step 340 discloses development of a stable, ORP-dependent bacterial community in the sludge layer.
Step 350 discloses digesting the sludge by fermentative bacteria at the lower section of the sludge layer-The fermentative layer. The fermentation process takes place at the bottom part of the sludge layer. The fermentation process results in the production of CO₂ gas and volatile fatty acids (VFAs). The produced CO₂ moves upwards to the gaseous layer and eventually to the atmosphere.
Step 360 discloses consuming the VFAs by denitrifying bacteria located at the upper fraction of the sludge layer-The denitrifying layer. The VFA consumption process results in the transformation of nitrate to elemental nitrogen gas, and VFAs oxidation to CO₂ gas. Both nitrogen and CO₂ gases move to the gaseous layer and eventually to the atmosphere.
Step 370 discloses geosmin and 2-methylisoborneol adsorbed onto sludge particles in the denitrifying sludge layer, and subsequently degraded by terpene-degrading bacteria.

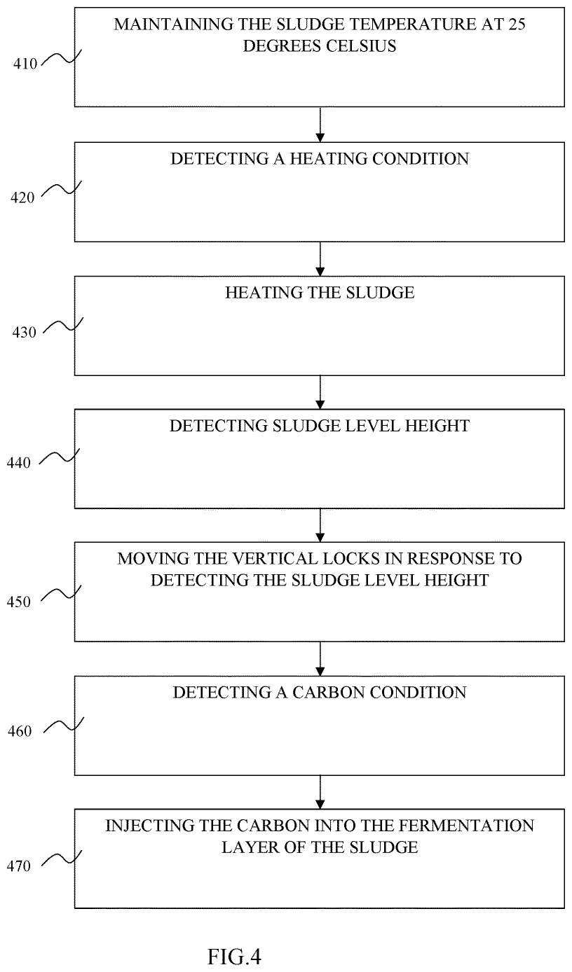

FIG. 4 shows a method of regulating the transfer of the wastewater in a closed system, according to exemplary embodiments of the present invention.
Step 410 discloses maintaining the sludge at a given range of temperature, for example at 25 degrees Celsius. This temperature control may be done using temperature sensors and heat-exchangers located inside the system, for example secured to the base and sidewalls of the rings and the central container.
Step 420 discloses detecting a heating condition in the sludge layer. The heating condition is defined as a biological, chemical, or physical condition that requires the system to heat the sludge. Such heating conditions may be in case the denitrification rate of the sludge is lower than 3 mg NO₃-N/m²/hour. Another optional heating condition is in case the oxidation-reduction potential (ORP) of the sludge is higher than [−]200 mV. Another optional heating condition is in case the outlet pH levels are lower than the inlet pH levels.
Step 430 discloses heating the sludge. Heating may be done in response to detecting the heating condition. The heating process may differ from one heating condition to another. for example, heating to 28 degrees Celsius in case the first heating condition is detected and heating to 30 degrees Celsius in case the second heating condition is detected.
Step 440 discloses detecting sludge level height. The detection may be done using a sensor, for example an image sensor, a humidity sensor, a temperature sensor, weight, a proximity sensor, a laser beam and the like. Controlled by the various vertical locks.
Step 450 discloses moving the vertical locks in response to detecting the sludge level height. For example, vertical locks are normally closed. When the sludge layer reaches a height of 0.5 meters above the base of one of the rings or the, the vertical lock of the relevant ring is lifted. Lifting may be performed according to a set of rules. For example, first lifting is from 0.5 meters to 1 meter high. This facilitates to movement of the sludge layer on the horizontal axis, thus lowering the sludge level at the vertical axis. When the sludge layer height reaches 1 meter from the floor, the vertical locks are lifted to 100% position, allowing the sludge layer to further move horizontally on the base of the respective ring.
Step 460 discloses detecting a carbon-limited condition. The carbon-limited condition is defined as a biological, chemical, or physical condition that requires the system to inject carbon sources into the sludge. The carbon-limited condition may be detected using a chemical sensor that measures the Carbon/Nitrogen (C/N) ratio of the sludge or using standard laboratory equipment. In some cases, the carbon limited condition is the case in which the C/N ration of the sludge is lower than 3(COD/NO₃-N (w/w)).
Step 470 discloses injecting the carbon into the fermentation layer of the sludge. This injection may be performed using a tube coupled to a carbon source, such as a carbon container located near the system, for example near the external ring, or above one of the rings or the central container.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

While the disclosure has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings without departing from the essential scope thereof. Therefore, it is intended that the disclosed subject matter is not limited to the particular embodiment disclosed as the best mode contemplated for carrying out this invention, but only by the claims that follow.

1. A system for removing compounds from liquids, the system comprises:
multiple ring-shaped channels that enable flow of liquids from one ring-shaped channel to another ring-shaped channel;
an inlet coupled to one of the ring-shaped channels, said inlet receives the liquids that comprises the compounds to be removed;
a central container coupled surrounded by the multiple ring-shaped channels;
a tube coupled to the central container, said tube is configured to output the treated liquids from the system;
a temperature unit configured to regulate the temperature of the liquids in the multiple ring-shaped channels;
a carbon source reservoir and delivery system for supplying carbon source to at least one of the multiple ring-shaped channels;
one or more sensors configured to collect information about the liquids in the multiple ring-shaped channels;
a control unit configured to receive the information from the one or more sensors, said control unit activates the carbon reservoir, the temperature unit and the vertical locks according to the collected information.

2. The system of claim 1, wherein the multiple ring-shaped channels are concentric.

3. The system of claim 1, wherein the multiple ring-shaped channels and the central container comprise a base and sidewalls extending upwards from the base.

4. The system of claim 1, further comprises an outlet pipe coupled to the tube, said outlet pipe is configured to transfer the treated liquids from the central container to a remote tank.

5. The system of claim 1, wherein the reactor is configured to operate in aquaculture systems that operate at water temperatures of 10-30° C.

6. The system of claim 1, wherein the multiple ring-shaped channels comprise at least an external ring that surrounds an internal ring, wherein the inlet is coupled to the external ring shaped channel.

7. The system of claim 6, wherein the external ring comprises a deflector located substantially close to the inlet, such that the deflector regulates a direction of liquid flow in the external ring.

8. The system of claim 6, wherein the external ring and the internal ring comprise one or more movable vertical locks configured to regulate the flow of liquid in the rings.

9. A method for removing compounds from liquids, the method comprises:
receiving wastewater flow into one of multiple ring-shaped channels;
forcing the wastewater to flow in a unidirectional manner along the multiple ring-shaped channels;
formation of the sludge layer at the base of the multiple ring-shaped channels;
digesting the sludge layer by fermentative bacteria at a lower section of the sludge layer.

10. The method of claim 9, wherein the digesting further comprises a fermentation process results in production of CO₂ gas and volatile fatty acids (VFAs).

11. The method of claim 9, further comprises absorbing geosmin and 2-methylisoborneol onto sludge particles in the sludge layer, and subsequently degraded by terpene-degrading bacteria.

12. The method of claim 9, further comprises maintaining the sludge at a given range of temperature;
detecting a heating condition of the sludge layer;
heating the sludge.

13. The method of claim 9, further comprises detecting sludge level height;
moving the vertical locks in response to detecting the sludge level height.

14. The method of claim 13, wherein the one or more vertical locks move upwards and downwards, wherein an upward position of the vertical locks prevents a passage of the liquids in the ring.

15. The method of claim 9, further comprises detecting a carbon-limited condition and injecting the carbon into the fermentation layer of the sludge.
